(19) United States
(12) Patent Application Publication
(10) Pub. No.: US 2011/0092615 A1
(43) Pub. Date: Apr. 21, 2011

(54) USE OF ALPHA-OLEFIN OR GLYCIDYL ETHER EPOXY-BASED POLYETHERS AS THICKENING AGENTS FOR WATER-BASED PAINT IN THE PRESENCE OF SURFACE ACTIVE AGENTS

(75) Inventors: Denis Ruhlmann, Genay (FR); Jean-Marc Suau, Lucenay (FR)

(73) Assignee: COATEX S.A.S., Genay (FR)

(21) Appl. No.: 12/996,491

(22) PCT Filed: Jun. 4, 2009
(86) PCT No.: PCT/IB2009/005869

§ 371 Date: Dec. 6, 2010

(30) Foreign Application Priority Data
Jun. 26, 2008 (FR) 08 54258

(51) Int. Cl. C09D 163/00

(52) U.S. Cl. 523/456

(57) ABSTRACT

The object of the invention is the use, as a thickening agent for a water-based paint, of an aqueous solution of a polyether of at least one polyoxyalkylene and at least one alpha-olefin epoxy, and/or at least one aliphatic or aromatic glycidyl ether, and at least one surface active agent whose chemical formula is CₓH₂ₓ₊₁—(OX)_{y}—OH where OX designates an oxylakylated unit, and characterized in that:
for the polyether, the molar ratio (polyoxyalkylene:alpha-olefin epoxy or aliphatic or aromatic glycidyl ether) is between (1:4) and (1:10),
for the surface active agent, 6≦x≦12 and 5≦y≦12,
said solution exhibits a mass ratio (polyether/surface active agent) of between 2.0 and 0.5, and exhibits a water content of 30% to 75% of its total weight.

Another object is the paint containing such a thickening system.

Polyether thickeners were developed as an alternative to their polyester counterparts, which exhibit only a very weak resistance to hydrolysis, which makes them unfit for use in aqueous formulations. Among these polyether thickeners, there is a particular class which consists of polyether thickeners modified by alpha-olefin epoxies. This class covers chemical structures whose molecular weight is generally less than 200,000 g/mole, obtained by means of a step of manufacturing a polyether, then a step of modifying said polyether through reaction with an alpha-olefin epoxy compound, or a glycidyl ether aliphatic or aromatic compound.

The first step in manufacturing the polyether consists of causing a polyoxyalkylene (and particularly an ethylene oxide, propylene oxide, or mixtures thereof) to react with a compound having an active hydrogen atom (initiator), in the presence of an oxyalkylation catalyst which is generally an acid or a base, at a temperature between 50° C. and 120° C., if not greater, as indicated in the document “Synthesis of polyether polyols for rigid polyurethane foams by alkoxylation of solid polyols in polyether media” (Polyurethanes 94, Proc. Polyurethanes Conf. (1994), 506-14 published by: Soc. Plast. Ind. Polyurethane Div., New York, N.Y.).

The second step consists of causing the previously obtained polyether to react with an epoxy compound, a temperature between 20° C. and 200° C., as indicated in the document U.S. Pat. No. 3,475,499 published in 1967, and which describes epoxidation between an alpha-olefin and an inorganic hydroperoxide, and the reaction of the 1,2-epoxy obtained with water or glycol ethylene.

This latter document, however, does not reveal particular applications for the synthesized polymers. There were no traces in the state of the art of a particular implementation of such structures before the 1970s: that of thickening agents in aqueous formulations which are hydraulic fluids, as claimed by numerous patents filed in the name of the company BASF™. Thus, the documents U.S. Pat. No. 4,288,639, U.S. Pat. No. 4,310,436, U.S. Pat. No. 4,354,956, U.S. Pat. No. 4,390,440, U.S. Pat. No. 4,411,819, U.S. Pat. No. 4,649,224, U.S. Pat. No. 4,665,239, U.S. Pat. No. 4,709,099, U.S. Pat. No. 4,673,518, describe polyether thickeners whose molecular weight is between 1,000 g/mol and 75,000 g/mol, modified with alpha-olefin epoxies having 12 to 18 carbon atoms and which represent 1% to 20% by weight of the total polymer composition. The issue covered by these patents is that of rheological agents for hydraulic fluids, which are effective under particular conditions of implementation, such as high temperature and pressure, or very high shear stress.

Afterward, that same company patented the use of these structures in the field of pharmacy and cosmetics, particularly as thickening agents in low doses and enabling the creation of clear gels (see documents U.S. Pat. No. 4,810,503, U.S. Pat. No. 4,904,466) and in the formulation of thickened pesticides (see the document US 2007 0049499).

Around the same time, another company (HERCULES™) also patented variants of these structures in the field of drilling fluids (see documents GB 2 065 150 and U.S. Pat. No. 4,304,902), but most importantly it conceived of their usage in the field of water-based paints for the first time. Thus, the document EP 0 138 614 describes paint compositions containing ethylene oxide and epoxy-alkane based polymers, having from 8 to 26 carbon atoms, whose molecular weight is between 50,000 g/mol and 320,000 g/mol, and which are used as a colloidal and thickening agent.

This latter patent seems to be the only document (though relatively old, as it was published in 1984) on the use of modified polyethers with alpha-olefin epoxies, in the field of water-based paints. The explanation why is explicitly given in the more recent document WO 96/31550, which criticizes the drawbacks of these polymers when they are implemented in water-based paints. This patent covers different structures: polymers having a poly(acetal- or cetal-polyether) skeleton, with hydrophobic groups chosen from among the alkyl, aryl, alkylaryl, cycloaliphatic, perfluoralkyl, carbosylil, and polycyclyl groups. In its background, this patent indicates (page 5, lines 1-4) that it seeks to remedy the relative ineffectiveness of the prior art's polyether thickeners modified with alpha-olefin epoxies, in order to satisfactorily thicken an water-based paint. More precisely, this document WO 96/31550 refers very clearly to the structures described in the prior art: it cites patents covering the use of these polymers in the field of hydraulic fluids, which had already been mentioned.

In paints, this lack of effectiveness by polyethers modified with alpha-olefin epoxies is related to the fact that such polymers, implemented in the form of aqueous solutions based on surface active agents, have difficulty or are slow in dispersing within the paints within which said aqueous solutions are added: the reactivity of these polyethers (or their ability to quickly thicken the medium in which they are added) is lessened.

Additionally, these aqueous solutions which contain modified polyethers as well as surface active agents are complex formulations whose viscosity, if it is too high, leads to a product which is difficult to store and handle.

In light of these drawbacks, the aforementioned document WO 96/31550 proposes as a solution polymers with poly(acetal- or cetal-polyether) skeletons, with hydrophobic groups. However, it appears for such structures that the substitution reaction can only be carried out by monofunctionalization; the effectiveness of the resulting polymer will therefore be a function of the length of the substituting chain, and the molecular weight of the polyacetal. However, using this method it is not possible to increase the number of substituents at the end of the chain so as to regulate the effectiveness of the final polymer, unlike a cycloaddition polymerization reaction.

Consequently, developing a way to:
improve the thickening effectiveness in water-based paints of polyethers modified with alpha-olefin epoxies or glycidyl ethers,
while reducing the viscosity of the aqueous solutions of surface active agents containing said modified polyethers,
   remains a problem unresolved from the prior art for more than 30 years (particularly since the publication of the document EP 0 138 614).

Pursuing her research in this direction, the Applicant has developed the use, as a thickening agent for a formulation of water-based paint, of an aqueous solution containing:
a) water,
b) at least one polyether of at least one polyoxyalkylene and at least one alpha-olefin epoxy, and/or at least one aliphatic or aromatic glycidyl ether,
c) and at least one surface active agent with the chemical formula:

CₓH₂ₓ₊₁—(OX)_{y}—OH in which OX designates an oxyalkylated unit,

characterized in that:
for the polyether, the molar ratio (polyoxyalkylene:alpha-olefin epoxy or aliphatic or aromatic glycidyl ether) is between (1:4) and (1:10),
for the surface active agent, 6≦x≦12 and 5≦y≦12,
for the aqueous solution, it has a mass ratio (polyether/surface active agent) between 2.0 and 0.5 and a water content between 30% and 75% of its total weight.

By altering the particular choice of the characteristic of the surface active agent and polyether as described above, the result, surprisingly as it was not instructed or disclosed in the prior art, is:
The development of a solution whose rheological behavior is in keeping with the requirements of stability and handling: in this matter, the person skilled in the art is looking for a Brookfield™ viscosity, measured at 100 revolutions/minute and at 25° C., of between 1,000 mPa·s and 15,000 mPa·s;
which could thicken the aqueous phase in which it is added, even at a low concentration of active ingredient (particularly 2% by weight of the polyether compared to the total weight of the formulation thereby thickened): this means achieving a Brookfield viscosity Brookfield™, measured at 100 revolutions/minute and at 25° C., greater than 1,000 mPa·s (forming a “2% gel”);
which may effectively thicken an water-based paint.

The examples clearly demonstrates that choosing the particular conditions regarding the surface active agent and the polyether is what makes it possible to achieve the properties mentioned above. Nothing in the state of the art concerned this complex technical problem. Moreover, nothing attracted the attention of the person skilled in the art in view of resolving such a problem, regarding the implementation of particular surface active agents, in combination with very specific polyethers which are the result of polymerization between a polyoxyalkylene and an alpha-olefin epoxy and/or a glycidyl ether. Finally, nothing disclosed nor suggested the particular characteristics of said surface active agent and said polyether as described above.

Thus, a first object of the invention consists of the use, as a thickening agent for a formulation of water-based paint, of an aqueous solution containing:
a) water,
b) at least one polyether of at least one polyoxyalkylene and at least one alpha-olefin epoxy, and/or at least one aliphatic or aromatic glycidyl ether,
c) and at least one surface active agent with the chemical formula:

CₓH₂ₓ₊₁—(OX)_{y}—OH in which OX designates an oxyalkylated unit,

characterized in that:
for the polyether, the molar ratio (polyoxyalkylene:alpha-olefin epoxy or aliphatic or aromatic glycidyl ether) is between (1:4) and (1:10),
for the surface active agent, 6≦x≦12 and 5≦y≦12,
for the aqueous solution, it has a mass ratio (polyether/surface active agent) between 2.0 and 0.5 and a water content between 30% and 75% of its total weight.

This use is further characterized in that said aqueous solution exhibits a Brookfield™ viscosity measured at 25° C. and at 100 revolutions/minute, of between 1,000 mPa·s and 15,000 mPa·s.

This use is further characterized in that said polyether is the result of the polymerization:
a) of at least one polyoxyalkylene having 2 to 3 carbon atoms, and having at least two alcohol functions,
b) and of at least one alpha-olefin epoxy having 6 to 40 carbon atoms, preferentially 12 to 18 carbon atoms, and/or of at least one aliphatic or aromatic glycidyl ether.

This use is further characterized in that said polyether exhibits a molecular weight between 5,000 g/mol and 100,000 g/mol, preferentially between 15,000 g/mol and 50,000 g/mol.

This use is further characterized in that said polyether is obtained by cycloaddition, at a temperature of between 50° C. and 200° C., potentially in the presence of at least one antioxidant agent.

A second object of the invention consists of a formulation of water-based paint, containing, as a thickening agent, an aqueous solution that contains:
a) water,
b) at least one polyether of at least one polyoxyalkylene and at least one alpha-olefin epoxy, and/or at least one aliphatic or aromatic glycidyl ether,
c) and at least one surface active agent with the chemical formula:

CₓH₂ₓ₊₁—(OX)_{y}—OH in which OX designates an oxyalkylated unit,

characterized in that:
for the polyether, the molar ratio (polyoxyalkylene:alpha-olefin epoxy or aliphatic or aromatic glycidyl ether) is between (1:4) and (1:10),
for the surface active agent, 6≦x≦12 and 5≦y≦12,
for the aqueous solution, it has a mass ratio (polyether/surface active agent) between 2.0 and 0.5 and a water content between 30% and 75% of its total weight.

This formulation is further characterized in that said polyether is the result of the polymerization:
a) of at least one polyoxyalkylene having 2 to 3 carbon atoms, and having at least two alcohol functions,
b) and of at least one alpha-olefin epoxy having 6 to 40 carbon atoms, preferentially 12 to 18 carbon atoms, and/or of at least one aliphatic or aromatic glycidyl ether.

This formulation is further characterized in that said polyether exhibits a molecular weight between 5,000 g/mol and 100,000 g/mol, preferentially between 15,000 g/mol and 50,000 g/mol.

This formulation is further characterized in that said polyether is obtained by cycloaddition, at a temperature of between 50° C. and 200° C., potentially in the presence of at least one antioxidant agent.

This formulation of water-based paint is further characterized in that it is a lacquer or varnish.

### EXAMPLES

The following tests illustrate combinations of surface active agents and polyethers outside of the invention, or according to the invention, depending on their characteristics.

Table 1 summarizes the composition of the various combinations.

Each of them is made up of 50% water by weight.

In each test, the polyether (PE) implements a polyethylene glycol (PEG) whose molecular weight is equal to 10,000 g/mol, and the carbon number of the epoxy or glycidyl ether has been indicated (Epox).

The molar ratio between the polyethylene glycol (PEG) and the glycidyl epoxy or ether (Epox), or PEG/Epox, is indicated.

In each test, the surface active agent (SAA) matches the formula CₓH₂ₓ₊₁—(OE)_{y}-OH, in which OE designates the ethylene oxide, and the values x and y are indicated.

The mass ratio between the polyether (PE) and the surface active agent (SAA), or PE/SAA, is also indicated.

OI and IN will respectively designate a test outside the invention and a test according to the invention.

The nature of the glycidyl epoxy or ether implemented, as well as that of the surface active agent, is indicated:
test 1 implements epoxydodecane (ARKEMA™) and Mergital™ D5 (COGNIS™);
test 2 implements epoxydodecane (ARKEMA™) and NP 6 (oxyethylated nonyl phenol, ALDRICH);
test 3 implements epoxydodecane and Lutensol™ 40 (BASF™);
test 4 implements epoxydecane (ARKEMA™) and Lutensol™ 70 (BASF™);
test 5 implements epoxydodecane (ARKEMA™) and Soprophor™ BO 327 (RHODIA™);
test 6 implements epoxydecane (ARKEMA™) and Lutensol™ 100 (BASF™);
test 7 implements epoxydodecane (ARKEMA™) and Lutensol™ 100 (BASF™);
test 8 implements epoxydodecane (ARKEMA™) and Lutensol™ 80 (BASF™);
test 9 implements epoxydodecane (ARKEMA™) and Lutensol™ 90 (BASF™);
test 10 implements epoxydodecane (ARKEMA™) and Lutensol™ 100 (BASF™);
test 11 implements epoxydodecane (ARKEMA™) and TD 180 (COGNIS™);
test 12 implements epoxydodecane (ARKEMA™) and TD 10 (COGNIS™);
test 13 implements epoxydodecane (ARKEMA™) and Rhodasurf™ ID 110 (RHODIA™);
test 14 implements epoxydodecane (ARKEMA™) and Mergital™ D8 (COGNIS™);
test 15 implements Cardolite™ NC 513 (phenyl glycidyl ether—CARDOLITE™) and Mergital™ D8 (COGNIS™);
test 16 implements HAGE™ 16 L (aliphatic glycidyl ether—SACHEM™) and Mergital™ D8 (COGNIS™);
test 17 implements HAGE™ 16 L (aliphatic glycidyl ether—SACHEM™) and Mergital™ D8 (COGNIS™);
test 18 implements HAGE™ 16 L (aliphatic glycidyl ether—SACHEM™) and Mergital™ D8 (COGNIS™);
test 19 implements Erysis™ GE 12 (CVC Specialties™) and Mergital™ D8 (COGNIS™);
test 20 implements Erysis™ GE 12 (CVC Specialties™) and Mergital™ D8 (COGNIS™);
test 21 implements Erysis™ GE 12 (CVC Specialties™) and Mergital™ D8 (COGNIS™);

TABLE 1

| | Polyether | | Surface Active Agent | | | | |
|---|---|---|---|---|---|---|---|
| | (PE) | | (SAA) | | | PE/ | IN/ |
| Test | Epox | PEG/Epox | Name | x | y | SAA | OI |
| 1 | C12 | 1:6 | Mergital D5 | 10 | 5 | 1 | OI |
| 2 | C12 | 1:7 | NP6 | 15 | 6 | 0.8 | OI |
| 3 | C12 | 1:8 | Lutensol 40 | 10 | 4 | 0.9 | OI |
| 4 | C10 | 1:9 | Lutensol 70 | 10 | 7 | 1.1 | OI |
| 5 | C12 | 1:10 | Soprophor BO327 | 9-11 | 5 | 0.8 | OI |
| 6 | C10 | 1:2 | Lutensol 100 | 10 | 10 | 0.8 | OI |
| 7 | C12 | 1:3 | Lutensol 100 | 10 | 10 | 0.8 | OI |
| 8 | C12 | 1:7 | Lutensol 80 | 10 | 8 | 0.6 | IN |
| 9 | C12 | 1:7 | Lutensol 90 | 10 | 9 | 0.85 | IN |
| 10 | C12 | 1:7 | Lutensol 100 | 10 | 10 | 0.85 | IN |
| 11 | C12 | 1:7 | TD 180 | 13 | 8 | 0.6 | IN |
| 12 | C12 | 1:7 | TD 10 | 13 | 10 | 0.85 | IN |
| 13 | C12 | 1:7 | Rhodasurf ID110 | 10 | 11 | 0.85 | IN |
| 14 | C12 | 1:7 | Mergital D8 | 10 | 8 | 0.85 | IN |
| 15 | C15 | 1:8 | Mergital D8 | 10 | 8 | 1.5 | IN |
| 16 | C16 | 1:6 | Mergital D8 | 10 | 8 | 1.5 | IN |
| 17 | C16 | 1:4 | Mergital D8 | 10 | 8 | 1.5 | IN |
| 18 | C16 | 1:5 | Mergital D8 | 10 | 8 | 1.5 | IN |
| 19 | C15 | 1:7 | Mergital D8 | 10 | 8 | 0.85 | IN |
| 20 | C15 | 1:8 | Mergital D8 | 10 | 8 | 0.85 | IN |
| 21 | C15 | 1:9 | Mergital D8 | 10 | 8 | 0.85 | IN |

Each of these combinations is subjected to:
a visual observation regarding its clarity,
a Brookfield™ viscosity measurement, at 100 revolutions/minute and at 25° C. (or as-is viscosity) which reveals its fitness to be stored in a stable manner, and be easy to handle (expressed in mPa·s),
a Brookfield™ viscosity measurement, at 10 revolutions/minute and at 25° C., once added to water at a rate of 2% by dry weight of polymer (viscosity of the 2% gel) which reveals its fitness to thick in an aqueous phase, even in a low concentration (expressed in mPa·s).

These values are given in Table 2.

It is observed that only the tests corresponding to the invention (tests #8 to 21) which did not solidify, gave rise to the production of clear formulations, and caused a thickening effect.

Furthermore, the formulations produced this way (tests #8 to 21) possess sufficiently high Brookfield™ viscosity values, so that the person skilled in the art can attest to the thickening nature of the polyether/surface active agent system implemented.

TABLE 2

| Test | IN/OI | Observations | μBk₁₀₀ (as-is) | μBk₁₀ (2% gel) |
|---|---|---|---|---|
| 1 | OI | solidification | — | — |
| 2 | OI | solidification | — | — |
| 3 | OI | solidification | — | — |
| 4 | OI | solidification | — | — |
| 5 | OI | solidification | — | — |
| 6 | OI | clear | <100 | <500 |
| 7 | OI | clear | <100 | <500 |
| 8 | IN | clear | 2,300 | 6,500 |
| 9 | IN | clear | 2,800 | 30,000 |
| 10 | IN | clear | 2,900 | 40,000 |
| 11 | IN | clear | 2,750 | 20,000 |
| 12 | IN | clear | 2,600 | 34,000 |
| 13 | IN | clear | 2,500 | 21,250 |
| 14 | IN | clear | 2,450 | 16,000 |
| 15 | IN | clear | 2,600 | 1,340 |
| 16 | IN | clear | 2,100 | 1,680 |
| 17 | IN | clear | 3,500 | 6,800 |
| 18 | IN | clear | 2,360 | 2,240 |
| 19 | IN | clear | 2,850 | 1,350 |
| 20 | IN | clear | 3,000 | 9,000 |
| 21 | IN | clear | 3,150 | 21,000 |

Finally, a certain number of other combinations according to the invention, whose compositions are given in Table 3, were produced (tests #22 to 28).

TABLE 3

| | | | Surface Active | | | | | |
|---|---|---|---|---|---|---|---|---|
| | Polyether | | Agent | | | | | |
| | (PE) | | (SAA) | | | PE/ | μBk₁₀₀ | IN/ |
| Test | Epox | PEG/Epox | Name | x | y | SAA | (as-is) | OI |
| 22 | C12 | 01:07 | Lutensol 80 | 10 | 8 | 1.5 | 5,000 | IN |
| 23 | C12 | 01:07 | Lutensol 90 | 10 | 9 | 1.5 | 6,000 | IN |
| 24 | C12 | 01:07 | Lutensol 100 | 10 | 10 | 1.5 | 8,000 | IN |
| 25 | C12 | 01:07 | TD 180 | 13 | 8 | 1.5 | 11,000 | IN |
| 26 | C12 | 01:07 | TD 10 | 13 | 10 | 1.5 | 4,850 | IN |
| 27 | C15 | 01:08 | Mergital D8 | 10 | 8 | 1.5 | 6,700 | IN |
| 28 | C15 | 01:09 | Mergital D8 | 10 | 8 | 1.5 | 8,700 | IN |

These combinations were developed in an unpigmented formulation of paint, whose composition is:
7.5 g of said combination,
200 g of Mowilith™ LDM 1871 (CELANESE™),
92.5 g of water,
7.5 g of Nopco™ NDW (NOPCO™)
of ammonia hydroxide to adjust the pH to a value between 8.5 and 9.

According to the well-known methods of the person skilled in the art, the Brookfield™ were then determined at 25° C., at 10 and 100 revolutions/minute (mPa·s), Stormer™ (KU) and ICI™ (Poise), at the moments t=0 and t=24 hours. These values were listed in Table 4.

The results obtained are rheologically typical of a paint that is easy to use and apply, meaning that it exhibits good stability in the container, without sedimentation, nor excessive separation of phases, with the application tool (roller, brush) properly loaded, and with good application quality (brush, roller, spraying). The growth of viscosity between t=0 and t=24 is characteristic of that observed for most aqueous-phase paints.

TABLE 4

| Test no. | Viscosity | t = 0 | t = 24 |
|---|---|---|---|
| 22 | Brookfield ™ 100 | 2,700 | 4,150 |
| | Brookfield ™ 10 | 13,100 | 25,100 |
| | Stormer ™ | 99 | 111 |
| | ICI ™ | 0.9 | 0.9 |
| 23 | Brookfield ™ 100 | 4,400 | 4,790 |
| | Brookfield ™ 10 | 23,200 | 36,900 |
| | Stormer ™ | 117 | 121 |
| | ICI ™ | 0.7 | 0.8 |
| 24 | Brookfield ™ 100 | 2,200 | 4,280 |
| | Brookfield ™ 10 | 13,400 | 27,700 |
| | Stormer ™ | 94 | 112 |
| | ICI ™ | 0.8 | 1 |
| 25 | Brookfield ™ 100 | 5,380 | 5,500 |
| | Brookfield ™ 10 | 33,400 | 38,800 |
| | Stormer ™ | 116 | 120 |
| | ICI ™ | 0.8 | 0.8 |
| 26 | Brookfield ™ 100 | 2,600 | 5,410 |
| | Brookfield ™ 10 | 10,200 | 33,100 |
| | Stormer ™ | 103 | 121 |
| | ICI ™ | 0.7 | 0.7 |
| 27 | Brookfield ™ 100 | 2,630 | 3,810 |
| | Brookfield ™ 10 | 16,000 | 28,300 |
| | Stormer ™ | 99 | 110 |
| | ICI ™ | 0.8 | 0.8 |
| 28 | Brookfield ™ 100 | 2,170 | 2,980 |
| | Brookfield ™ 10 | 11,800 | 20,500 |
| | Stormer ™ | 89 | 100 |
| | ICI ™ | 0.6 | 0.7 |

1. A process for thickening a formulation of water-based paint, the process comprising combining an aqueous solution comprising:
a) water;
b) at least one polyether of at least one polyoxyalkylene and at least one alpha-olefin epoxy, and/or at least one aliphatic or aromatic glycidyl ether; and
c) at least one surface active agent with a chemical formula:
CₓH₂ₓ₊₁—(OX)_{y}—OH, in which OX designates an oxyalkylated unit,
with a water-based paint formulation component,
wherein:
for the at least one polyether, a molar ratio of polyoxyalkylene: alpha-olefin epoxy or aliphatic or aromatic glycidyl ether is between 1:4 and 1:10;
for the at least one surface active agent, 6≦x≦12 and 5≦y≦12; and the aqueous solution has a mass ratio, polyether/surface active agent, between 2.0 and 0.5 and a water content between 30% and 75% of a total weight of the aqueous solution.

2. The process of claim 1, wherein said aqueous solution exhibits a Brookfield™ viscosity measured at 25° C. and at 100 revolutions/minute, of between 1,000 mPa·s and 15,000 mPa·s.

3. The process of claim 1, wherein said polyether is obtained by polymerizing:
a) at least one polyoxyalkylene having 2 to 3 carbon atoms, and having at least two alcohol functions; and
b) at least one alpha-olefin epoxy having 6 to 40 carbon atoms, and/or of at least one aliphatic or aromatic glycidyl ether.

4. The process of claim 1, wherein an associative thickener from b) exhibits a molecular weight between 5,000 g/mol and 100,000 g/mol.

5. The process of claim 1, wherein said polyether is obtained by cycloaddition, at a temperature between 50° C. and 200° C., optionally in the presence of at least one antioxidant agent.

6. A formulation of water-based paint, comprising as a thickening agent an aqueous solution comprising:
a) water;
b) at least one polyether of at least one polyoxyalkylene and at least one alpha-olefin epoxy, and/or at least one aliphatic or aromatic glycidyl ether; and
c) at least one surface active agent with a chemical formula:
CₓH₂ₓ₊₁—(OX)_{y}—OH, in which OX designates an oxyalkylated unit;
wherein:
for the at least one polyether, a molar ratio of polyoxyalkylene: alpha-olefin epoxy or aliphatic or aromatic glycidyl ether is between (1:4) and (1:10),
for the at least one surface active agent, 6≦x≦12 and 5≦y≦12; and
the aqueous solution has a mass ratio of polyether/surface active agent between 2.0 and 0.5 and a water content between 30% and 75% of a total weight of the aqueous solution.

7. The formulation of claim 6, wherein said polyether is obtained by polymerizing:
a) at least one polyoxyalkylene having 2 to 3 carbon atoms, and having at least two alcohol functions; and
b) at least one alpha-olefin epoxy having 6 to 40 carbon atoms, and/or of at least one aliphatic or aromatic glycidyl ether.

8. The formulation of claim 6, wherein an associative thickener from b), exhibits a molecular weight between 5,000 g/mol and 100,000 g/mol.

9. The formulation according to of claim 6, wherein said polyether is obtained by cycloaddition, at a temperature between 50° C. and 200° C., optionally in the presence of at least one antioxidant agent.

10. The formulation of claim 6, in the form of a lacquer or varnish.

11. The process of claim 3, wherein the at least one alpha-olefin epoxy has 12 to 18 carbon atoms.

12. The process of claim 1, wherein an the associative thickener from b) exhibits a molecular weight between 15,000 g/mol and 50,000 g/mol.

13. The process of claim 5, wherein the at least one antioxidant agent is present.

14. The formulation of claim 7, wherein the at least one alpha-olefin epoxy has 12 to 18 carbon atoms.

15. The formulation of claim 6, wherein an associative thickener from b), exhibits a molecular weight between 15,000 g/mol and 50,000 g/mol.

16. The formulation of claim 9, wherein the at least one antioxidant agent is present.

17. The process of claim 2, wherein said polyether is obtained by polymerizing:
a) at least one polyoxyalkylene having 2 to 3 carbon atoms, and having at least two alcohol functions; and
b) at least one alpha-olefin epoxy having 6 to 40 carbon atoms, and/or of at least one aliphatic or aromatic glycidyl ether.

18. The process of claim 2, wherein an associative thickener from b) exhibits a molecular weight between 5,000 g/mol and 100,000 g/mol.

19. The process of claim 3, wherein an associative thickener from b) exhibits a molecular weight between 5,000 g/mol and 100,000 g/mol.

20. The process of claim 17, wherein an associative thickener from b) exhibits a molecular weight between 5,000 g/mol and 100,000 g/mol.
